(19) United States
(12) Patent Application Publication
(10) Pub. No.: US 2009/0237140 A1
(43) Pub. Date: Sep. 24, 2009

(54) Voltage Adder Using Current Source

(76) Inventors: Han Su Pae, Hwaseong-si (KR); Sang-moo Choi, Yongin-si (KR)

Correspondence Address: F. CHAU & ASSOCIATES, LLC, 130 WOODBURY ROAD, WOODBURY, NY, 11797, US

(21) Appl. No.: 12/391,925

(22) Filed: Feb. 24, 2009

(30) Foreign Application Priority Data
Mar. 24, 2008 (KR) 10-2008-0027060

(51) Int. Cl. G06G 7/14

(52) U.S. Cl. 327/361

(57) ABSTRACT

A voltage adder includes a first amplifier, a feedback resistor, and a control current source. The first amplifier includes a first input terminal to which a first voltage is input, a second input terminal connected to a feedback node, and an output terminal connected to an output node. The feedback resistor is connected between the output node and the feedback node. The control current source allows an addition current corresponding to a second voltage to flow through the feedback resistor.

### CROSS-REFERENCE TO RELATED APPLICATION

This application claims priority to and the benefit of Korean Patent Application No. 10-2008-0027060, filed on Mar. 24, 2008, in the Korean Intellectual Property Office, the entire content of which is incorporated herein by reference.

### BACKGROUND

1. Field of the Invention

The present invention relates to electronic circuits, and more particularly, to a voltage adder used in electronic circuits.

2. Description of the Related Art

A voltage adder is widely used in electronic circuits. An inverting adder or a non-inverting adder can be realized using an amplifier, such as an operational amplifier (Op-Amp).

FIG. 1 illustrates a conventional non-inverting adder which includes an amplifier AMP, a resistor Rf, and a resistor Ra. An input voltage VA is input to a positive terminal of the amplifier AMP. A negative terminal of the amplifier AMP is connected to a node Nf, and an output terminal of the amplifier AMP is connected to a node No. The resistor Rf is connected between the node No and the node Nf. A terminal of the resistor Ra is connected to the node Nf and the other terminal of the resistor Ra is connected to ground GND.

In terms of the characteristics of a virtual short circuit of the amplifier AMP, a voltage of the node Nf that is connected to the negative terminal of the amplifier AMP is substantially the same as the input voltage VA applied to the positive terminal of the amplifier AMP. Thus, a current Ia flowing through the resistor Ra satisfies VA/Ra. In this case, a voltage Vf across the resistor Rf satisfies Rf*(VA/Ra), and thus, an output voltage V_out at the node No is expressed by Equation (1) as follows:

$$\begin{matrix}V\_out = VA + Vf \\ = VA + {Rf}^{*} Ia \\ = VA + {Rf}^{*} ( VA / Ra ) \\ = VA + {VA}^{*} ( Rf / Ra ) \\ = {VA}^{*} [ 1 + ( Rf / Ra ) ] .\end{matrix} \qquad Equation ( 1 )$$

As shown in Equation (1), the voltage Vf across the resistor Rf is dependent on the input voltage VA. That is, if the input voltage VA varies, the voltage Vf across the resistor Rf also varies.

Accordingly, if independently setting the voltage Vf across the resistor Rf regardless of the input voltage VA is desired, the conventional non-inverting adder illustrated in FIG. 1 cannot be used. For example, if it is desired that the output voltage V_out be produced by adding a constant voltage Vf to a varying input voltage VA, the conventional non-inverting adder of FIG. 1, whereby the voltage Vf is dependent on the change of the input voltage VA, cannot be used.

### SUMMARY

In accordance with exemplary embodiments of the present invention a voltage adder is provided that adds two voltages that are independent from each other using a control current source.

In an exemplary embodiment of the present invention a voltage adder includes a first amplifier, a feedback resistor, and a control current source. The first amplifier includes a first input terminal to which a first voltage is applied, a second input terminal connected to a feedback node, and an output terminal connected to an output node. The feedback resistor is connected between the output node and the feedback node. The control current source allows an addition current corresponding to a second voltage to flow through the feedback resistor.

An output voltage obtained by adding k times the second voltage to the first voltage may be output at the output node, where k is a real number.

The first input terminal of the first amplifier may be a positive terminal. The second input terminal of the first amplifier may be a negative terminal. The first amplifier may be a non-inverting amplifier.

The control current source may include a second amplifier having a first input terminal to which the second voltage is applied; a first current path connected to the second amplifier and through which a control current corresponding to the second voltage flows; a second current path through which a mirror current corresponding to the control current flows; and a third current path through which the addition current corresponding to the mirror current flows.

The first current path may include: a p-type transistor comprising an input terminal connected to a power voltage, a control terminal connected to a p-type mirror node, and an output terminal connected to the p-type mirror node; an n-type transistor comprising an input terminal connected to the output terminal of the p-type transistor, a control terminal connected to an output terminal of the second amplifier, and an output terminal connected to a second input terminal of the second amplifier; and a control resistor connected between the output terminal of the n-type transistor and a reference node.

The control resistor may include first through N^{th} resistors which are connected in series (N being a natural number); first through N^{th} switches, wherein an n^{th} switch is connected to an n^{th} resistor in parallel (n being a natural number from 1 to N).

A resistance value of the control resistor may be adjusted according to the number of switches that are in a turn-on state among the first through N^{th} switches.

When a resistance value of the control resistor is the same as a resistance value of the feedback resistor, an output voltage obtained by adding the second voltage to the first voltage may be output at the output node.

The second current path may include: a p-type transistor having an input terminal connected to a power voltage, a control terminal connected to a p-type mirror node, and an output terminal connected to an n-type mirror node; and an n-type transistor having an input terminal connected to the output terminal of the p-type transistor, a control terminal connected to the n-type mirror node, and an output terminal connected to a reference node.

The third current path may include an n-type transistor having an input terminal that is directly or indirectly connected to the feedback node, a control terminal connected to an n-type mirror node, and an output terminal connected to a reference node.

The voltage adder may further include a blocking switch connected between the feedback node and the control current source.

According to another exemplary embodiment of the present invention, a voltage adder includes a first amplifier having a first input terminal to which a first voltage is applied, a second input terminal connected to a feedback node, and an output terminal connected to an output node; a feedback resistor connected between the output node and the feedback node; a blocking switch of which a first terminal is connected to the feedback node; and a control current source connected to a second terminal of the blocking switch, allowing an addition current corresponding to a second voltage to flow through the feedback resistor.

The first amplifier may be a high voltage device. The control current source may be a medium or low voltage device.

The blocking switch may block a high voltage from the first amplifier from being directly applied to the control current source.

### BRIEF DESCRIPTION OF THE DRAWINGS

FIG. 1 is a circuit diagram of a conventional non-inverting adder.

FIG. 2 is a circuit diagram of a voltage adder according to an exemplary embodiment of the present invention.

FIG. 3 is a circuit diagram of an exemplary control current source CCS of the voltage adder of FIG. 2,

FIG. 4 is a circuit diagram of an exemplary control resistor Rb of the control current source CCS of FIG. 3.

FIG. 5 is a circuit diagram of a voltage adder according to another embodiment of the present invention.

### DETAILED DESCRIPTION

Referring now to FIG. 2, the voltage adder includes a first amplifier AMP_A, a feedback resistor Rf, and a control current source CCS. The feedback resistor Rf is connected between an output node No and a feedback node Nf. The control current source CCS is connected between the feedback node Nf and a reference node Nr.

The first amplifier AMP_A includes a first input terminal to which a first voltage VA is applied, a second input terminal connected to the feedback node Nf, and an output terminal connected to the output node No. As illustrated in FIG. 2, the first input terminal of the first amplifier AMP_A is a positive terminal, and the second input terminal of the first amplifier AMP_A is a negative terminal. The first amplifier AMP_A may act as a non-inverting amplifier.

The CCS allows an addition current Is, corresponding to a second voltage VB, to flow through the feedback resistor Rf. Since the addition current Is flows through the feedback resistor Rf, a voltage Vf across the feedback resistor Rf is Rf*Is. In terms of the characteristics of a virtual short circuit of the first amplifier AMP_A, a voltage at the feedback node Nf is substantially the same as the first voltage VA. Thus, an output voltage V_out at the output node No is expressed by Equation (2) as follows:

$$\begin{matrix}V\_out = VA + Vf \\ = VA + {Rf}^{*} Is .\end{matrix} \qquad Equation ( 2 )$$

As shown in Equation (2), the voltage Vf across the feedback resistor Rf is independent from the first voltage VA. That is, a change of the first voltage VA does not affect the voltage Vf across the feedback resistor Rf. Regardless of the change of the first voltage VA, the voltage Vf across the feedback resistor Rf can be independently set by the control current source CCS. In this regard, the voltage adder of FIG. 2 can be used in a temperature correction circuit of organic light emitting diode (OLED) devices. That is, the voltage adder illustrated in FIG. 2 can be used to add the voltage Vf that is maintained as a constant set value regardless of the change of the first voltage VA according to temperature in OLED devices. Further, the voltage adder of FIG. 2 can be used when there is a need to add two voltages that are independent from each other.

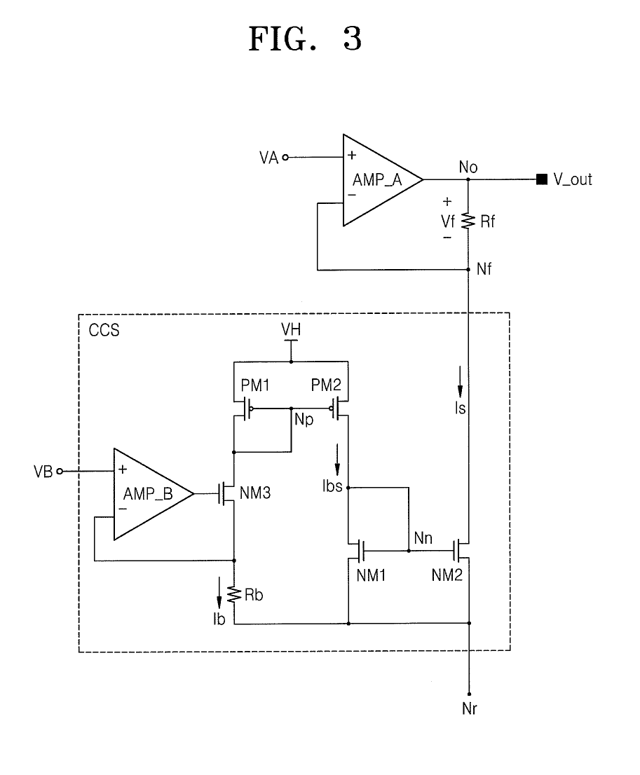

Referring now to FIG. 3, the control current source CCS includes a second amplifier AMP_B, a first current path through which a control current Ib flows, a second current path through which a mirror current Ibs flows, and a third current path through which the addition current Is flows. In particular, the first current path includes a p-type transistor PM1, an n-type transistor NM3, and a control resistor Rb. The second current path includes a p-type transistor PM2 and an n-type transistor NM1. The third current path includes an n-type transistor NM2.

The second amplifier AMP_B includes a first input terminal to which the second voltage VB is applied, a second input terminal connected to an output terminal of the n-type transistor NM3, and an output terminal connected to a control terminal of the n-type transistor NM3. As illustrated in FIG. 3, the first input terminal of the second amplifier AMP_B is a positive terminal, and the second input terminal of the second amplifier AMP_B is a negative terminal.

In the first current path, the p-type transistor PM1 includes an input terminal connected to a power voltage VH, a control terminal connected to a p-type mirror node Np, and an output terminal connected to the p-type mirror node Np. The n-type transistor NM3 includes an input terminal connected to the output terminal of the p-type transistor PM1, a control terminal connected to the output terminal of the second amplifier AMP_B, and an output terminal connected to the second input terminal of the second amplifier AMP_B. The control resistor Rb is connected between the output terminal of the n-type transistor NM3 and a reference node Nr. The control current Ib flows to the reference node Nr via the p-type transistor PM1, the n-type transistor NM3, and the control resistor Rb.

In the second current path, the p-type transistor PM2 includes an input terminal connected to the power voltage VH, a control terminal connected to the p-type mirror node Np, and an output terminal connected to an n-type mirror node Nn. The n-type transistor NM1 includes an input terminal connected to the output terminal of the p-type transistor PM2, a control terminal connected to the n-type mirror node Nn, and an output terminal connected to the reference node Nr. The mirror current Ibs flows to the reference node Nr via the p-type transistor PM2 and the n-type transistor NM1.

In the third current path, the n-type transistor NM2 includes an input terminal connected to the feedback node Nf, a control terminal connected to the n-type mirror node Nn, and an output terminal connected to the reference node Nr. Also, the addition current Is flows to the reference node Nr via the n-type transistor NM2.

In terms of the characteristics of a virtual short circuit of the second amplifier AMP_B, a voltage of the second input terminal is substantially the same as a voltage of the first input terminal. Thus, the control current Ib is expressed by Equation (3) below. As shown in Equation (3 ), the control current Ib corresponds to the second voltage VB.

Ib=VB/Rb Equation (3).

When p-type current mirrors formed by the p-type transistor PM1 and the p-type transistor PM2 have a current mirror ratio of 1:1, Ibs=Ib. In addition, when n-type current mirrors formed by the n-type transistor NM1 and the n-type transistor NM2 have a current mirror ratio of 1:1, Is=Ibs. Thus, when the current mirror ratio in the p-type current mirrors is 1:1 and the current mirror ratio in the n-type current mirrors is also 1:1, Is=Ib. In the current exemplary embodiment, the current mirror ratios of the control current source CCS are 1:1. However, embodiments of the present invention are not limited thereto, and thus, current mirror ratios other than 1:1 are possible in other embodiments in accordance with the present invention.

In the control current source CCS, the control current Ib depends on the second voltage VB, the mirror current Ibs corresponds to the control current Ib, and the addition current Is corresponds to the mirror current Ibs. In this regard, it is deemed that the addition current Is corresponds to the second voltage VB. When the current mirror ratios in the control current source CCS are 1:1, this satisfies Equation (4) below:

Ib=Is

VB/Rb=Vf/Rf

Vf=(Rf/Rb)*VB=k*VB

wherein, k=Rf/Rb Equation (4).

As shown in Equation (4), the voltage Vf across the feedback resistor Rf is k times larger than the second voltage VB. Thus, the output voltage V_out obtained by adding k times the second voltage VB to the first voltage VA is output at the output node No. In addition, when a resistance value of the control resistor Rb is the same as a resistance value of the feedback resistor Rf, that is, k=1, the output voltage V_out obtained by adding the second voltage VB to the first voltage VA is output at the output node No.

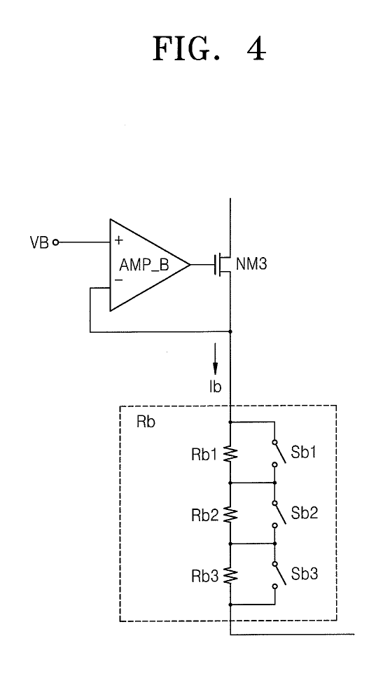

Referring now to FIG. 4 a circuit diagram of an exemplary control resistor Rb of the control current source CCS of FIG. 3 is shown. The control resistor Rb includes a first resistor Rb1 and a first switch Sb1 that are connected to each other in parallel, a second resistor Rb2 and a second switch Sb2 that are connected to each other in parallel, and a third resistor Rb3 and a third switch Sb3 that are connected to each other in parallel. The first resistor Rb1, the second resistor Rb2 and the third resistor Rb3 are connected to one another in series, thereby forming a resistor string. In FIG. 4, the three resistors Rb1, Rb2, Rb3 and three switches Sb1, Sb2, Sb3 are illustrated. However, embodiments of the present invention are not limited thereto, and thus, according to other embodiments, the control resistor Rb can include four or more resistors and switches.

As illustrated in FIG. 4, a resistance value of the control resistor Rb is adjusted according to the number of switches that are in a turn-on state among the first switch Sb1, the second switch Sb2 and the third switch Sb3. The greater the number of switches that are in a turn-on state, the smaller the resistance value of the control resistor Rb. The resistance value of the control resistor Rb is adjusted in this manner, and thus, k of Equation (4) can be set to a desired value.

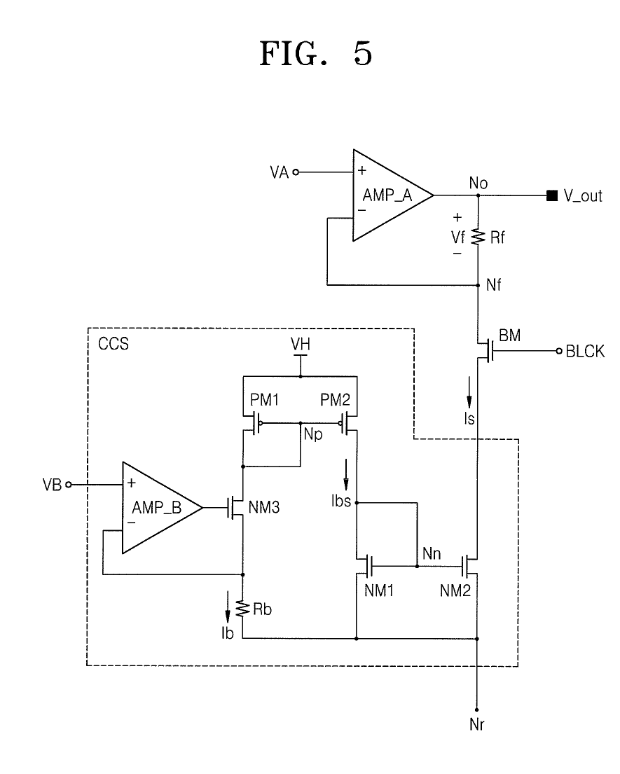

FIG. 5 is a circuit diagram of a voltage adder according to still another exemplary embodiment of the present invention.

A first amplifier AMP_A, a feedback resistor Rf, and a control current source CCS illustrated in FIG. 5 respectively correspond to the first amplifier AMP_A, the feedback resistor Rf, and the control current source CCS of FIG. 3. However, as seen in FIG. 5, the voltage adder further includes a blocking switch BM connected between the feedback node Nf and the control current source CCS.

In the voltage adder in accordance with an exemplary embodiment of the present invention, the first amplifier AMP_A may be a high voltage device, and the control current source CCS may be a medium or low voltage device. Even though the control current source CCS is not embodied as a high voltage device, a high-voltage output voltage V_out can be obtained by the configuration illustrated in FIG. 5. That is, by using the first amplifier AMP_A, as the high voltage device, together with the control current source CCS as the medium or low voltage device, a high voltage output can be obtained. When the control current source CCS is a medium or low voltage device, the control current source CCS, which does not need to cope with a high voltage, can have a relatively small area. Therefore, for the control current source CCS as the medium or low voltage device, an entire area of the voltage adder can be decreased.

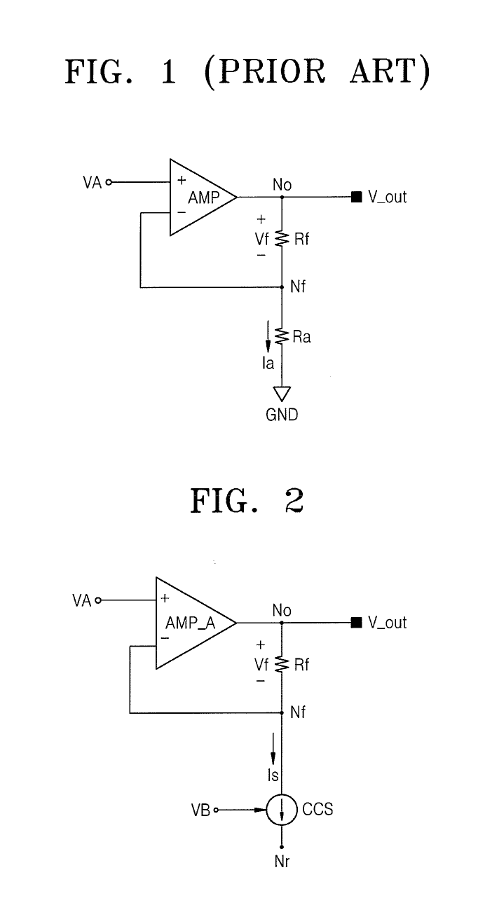

In the case of the conventional voltage adder of FIG. 1, to adjust the voltage Vf, the resistance value of the resistor Rf (or the resistor Ra) would be adjusted. When the resistor Rf embodied as a high voltage device includes the resistor string and the plurality of the switches as illustrated in FIG. 4, the resistance value of the resistor Rf may be adjusted by controlling the plurality of the switches. In this case, the plurality of the switches should be embodied as high voltage devices that can cope with a high voltage, and thus the area of the voltage adder increases and the signal controlling the plurality of the switches would have a wide voltage range. On the other hand, in the voltage adders illustrated in FIGS. 3 and 5, the addition current Is is adjusted by the control current source CCS as a medium or low voltage device, and thus the voltage Vf can be adjusted. The control resistor Rb of FIG. 4, which is used to adjust the addition current Is, would be a medium or low voltage device, and thus, the area of the control resistor Rb becomes small. In addition, the signal controlling the plurality of the switches included in the control resistor Rb would have a narrow voltage range, and thus, the power consumption becomes relatively small.

When the high voltage device is used together with the medium or low voltage device, that is, when the first amplifier AMP_A, as a high voltage device, is used together with the control current source CCS, as a medium or low voltage device, the blocking switch BM blocks a high voltage from the first amplifier AMP_A from being directly applied to the control current source CCS. To this end, the blocking switch BM may be a high voltage transistor. In FIG. 5, a first terminal of the blocking switch BM is connected to the feedback node Nf, and a second terminal of the blocking switch BM is connected to the control current source CCS. The blocking switch BM is controlled by a bias voltage BLCK input to a control terminal of the blocking switch BM. The fixed bias voltage BLCK is applied to the control terminal of the blocking switch BM, thereby causing a big voltage drop between the first terminal and the second terminal of the blocking switch BM. As a result, the high voltage from the first amplifier AMP_A can be blocked from being directly applied to the control current source CCS.

As illustrated in FIG. 3, the control current source CCS may be directly connected to the feedback node Nf, and as illustrated in FIG. 5, the control current source CCS may be indirectly connected to the feedback node Nf through the blocking switch BM.

While the present invention have been particularly shown and described with reference to exemplary embodiments thereof, it will be understood by those skilled in the art that various changes may be made therein without departing from the spirit and scope of the following claims.

What is claimed is:

1. A voltage adder comprising:
a first amplifier comprising a first input terminal to which a first voltage is applied, a second input terminal connected to a feedback node, and a first amplifier output terminal connected to an output node;
a feedback resistor connected between the output node and the feedback node; and
a control current source coupled between the feedback node and a reference node for allowing an addition current corresponding to a second voltage applied to the control current source to flow through the feedback resistor.

2. The voltage adder of claim 1, wherein a sum of k times the second voltage, k being a real number, and the first voltage is provided as an output voltage at the output node.

3. The voltage adder of claim 1, wherein the first input terminal is a positive terminal, the second input terminal is a negative terminal, and the first amplifier is a non-inverting amplifier.

4. The voltage adder of claim 1, wherein the control current source comprises:
a second amplifier comprising a first input terminal to which the second voltage is applied;
a first current path connected to the second amplifier and through which a control current corresponding to the second voltage flows;
a second current path through which a mirror current corresponding to the control current flows; and
a third current path through which the addition current corresponding to the mirror current flows.

5. The voltage adder of claim 4, wherein the first current path comprises:
a p-type transistor comprising an input terminal connected to a power voltage, a control terminal connected to a p-type mirror node, and an output terminal connected to the p-type mirror node;
an n-type transistor comprising an input terminal connected to the output terminal of the p-type transistor, a control terminal connected to an output terminal of the second amplifier, and an output terminal connected to a second input terminal of the second amplifier; and
a control resistor connected between the output terminal of the n-type transistor and the reference node.

6. The voltage adder of claim 5, wherein the first input terminal of the second amplifier is a positive terminal, and the second input terminal of the second amplifier is a negative terminal.

7. The voltage adder of claim 5, wherein the control resistor comprises:
first through N^{th} resistors connected in series, N being a natural number; and
first through N^{th} switches, an n^{th} switch being connected to an n^{th} resistor in parallel, n being a natural number from 1 to N.

8. The voltage adder of claim 7, wherein a resistance value of the control resistor is adjusted according to the number of switches which are in a turn-on state among the first through N^{th} switches.

9. The voltage adder of claim 5, wherein, when a resistance value of the control resistor is the same as a resistance value of the feedback resistor, a sum of the second voltage and the first voltage is provided as an output voltage at the output node.

10. The voltage adder of claim 4, wherein the second current path comprises:
a p-type transistor comprising an input terminal connected to a power voltage, a control terminal connected to a p-type mirror node, and an output terminal connected to an n-type mirror node; and
an n-type transistor comprising an input terminal connected to the output terminal of the p-type transistor, a control terminal connected to the n-type mirror node, and an output terminal connected to the reference node.

11. The voltage adder of claim 4, wherein the third current path comprises an n-type transistor comprising an input terminal that is connected to the feedback node, a control terminal connected to an n-type mirror node, and an output terminal connected to the reference node.

12. The voltage adder of claim 11, wherein the input terminal is directly connected to the feedback node.

13. The voltage adder of claim 11, wherein the input terminal is indirectly connected to the feedback node.

14. The voltage adder of claim 1, further comprising a blocking switch connected between the feedback node and the control current source.

15. A voltage adder comprising:
a first amplifier comprising a first input terminal to which a first voltage is applied, a second input terminal connected to a feedback node, and a first amplifier output terminal connected to an output node;
a feedback resistor connected between the output node and the feedback node;
a blocking switch having a first blocking switch terminal connected to the feedback node; and
a control current source connected to a second blocking switch terminal for allowing an addition current corresponding to a second voltage to flow through the feedback resistor.

16. The voltage adder of claim 15, wherein a sum of k times the second voltage, k being a real number, and the first voltage is provided as an output voltage at the output node.

17. The voltage adder of claim 15, wherein the first amplifier is a high voltage device, and the control current source is a medium or low voltage device.

18. The voltage adder of claim 17, wherein a high voltage from the first amplifier is blocked by the blocking switch from being directly applied to the control current source.

19. The voltage adder of claim 15, wherein the control current source comprises:
a second amplifier comprising a first input terminal to which the second voltage is applied;
a first current path connected to the second amplifier and through which a control current corresponding to the second voltage flows;
a second current path through which a mirror current corresponding to the control current flows; and
a third current path through which the addition current corresponding to the mirror current flows.

20. A method for adding voltages to output an output voltage at an output port of an operational amplifier having a positive input port, a negative input port, and a feedback resistor coupled between the output port and the negative input port, the operational amplifier having a virtual short circuit between the positive input port and the negative input port, the method comprising:
coupling a control current source to the negative input port, and
regulating current flow through the control current source such that a sum of a voltage applied to the control current source and a voltage applied to the positive input port is provided as the output voltage at the output port.
